(19) United States
(12) Patent Application Publication
(10) Pub. No.: US 2011/0243723 A1
(43) Pub. Date: Oct. 6, 2011

(54) FAN GUARD

(75) Inventor: CHIH-HUA CHEN, Tu-Cheng (TW)

(73) Assignee: HON HAI PRECISION INDUSTRY CO., LTD., Tu-Cheng (TW)

(21) Appl. No.: 12/890,855

(22) Filed: Sep. 27, 2010

(30) Foreign Application Priority Data
Mar. 30, 2010 (TW) 99109726

(51) Int. Cl. F03D 1/04

(52) U.S. Cl. 415/208.1

(57) ABSTRACT

A fan guard includes a bracket, a guide sheet and at least two guide ribs. The bracket defines a vent in the center of the bracket. The guide sheet is located in the center of the vent. The at least two guide ribs interconnect the bracket and the guide sheet. Each guide rib includes a first connecting portion and a second connecting portion connecting the first connecting portion. The first connecting portion and the second connecting portion cooperatively define a first angle therebetween.

### BACKGROUND

1. Technical Field

The present disclosure relates to fan guards, and particularly, to a fan guard capable of guiding airflow while mounted on a fan.

2. Description of the Related Art

Fans are widely used in many systems which generate heat and require dissipation thereof. For example, a computer housing can use a fan to dissipate heat generated by a CPU, a power source, or an expansion card of the computer. Oftentimes, the fans are mounted to a plurality of systems via a plurality of fan guards.

When operated, the fans can generate noise. Designers may decrease a speed of the fan to reduce the noise. However, the dissipation efficiency of the fan is decreased correspondingly.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a planar view of a first embodiment of a fan guard.

FIG. 2 is a planar view of a second embodiment of a fan guard.

FIG. 3 is a planar view of a third embodiment of a fan guard.

FIG. 4 is a planar view of a fourth embodiment of a fan guard.

FIG. 5 is a planar view of a fifth embodiment of a fan guard.

FIG. 6 is a chart showing the results of prominence ratio testing of the first through fifth embodiments of the fan guards at low rotation speed while positively mounted on a fan.

FIG. 7 is a chart showing the results of prominence ratio testing of the first through fifth embodiments of the fan guards at low rotation speed while negatively mounted on a fan.

FIG. 8 is a chart showing the results of prominence ratio testing of the first through fifth embodiments of the fan guards at high rotation speed while positively mounted on a fan.

FIG. 9 is a chart showing the results of prominence ratio testing of the first through fifth embodiments of the fan guards at high rotation speed while negatively mounted on a fan.

FIG. 10 is a chart showing the results of loudness testing of the first through fifth embodiments of the fan guards at low rotation speed while positively mounted on a fan.

FIG. 11 is a chart showing the results of loudness testing of the first through fifth embodiments of the fan guards at low rotation speed while negatively mounted on a fan.

FIG. 12 is a chart showing the results of loudness testing of the first through fifth embodiments of the fan guards at high rotation speed while positively mounted on a fan.

FIG. 13 is a chart showing the results of loudness testing of the first through fifth embodiments of the fan guards at high rotation speed while negatively mounted on a fan.

### DETAILED DESCRIPTION

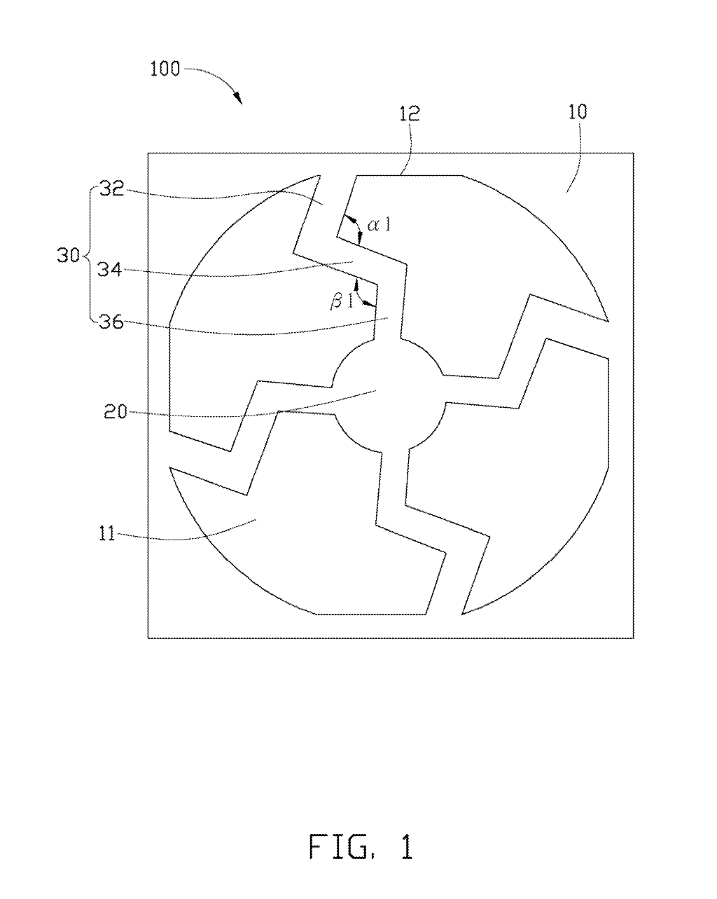

Referring to FIG. 1, a first embodiment of a fan guard 100 includes a bracket 10, a guide sheet 20 and four guide ribs 30. The bracket 10 is substantially rectangular, and defines a vent 11 in the center of the bracket 10 and four planar portions 12 in the sidewalls of the vent 11. The four planar portions 12 are parallel to four outer edges of the bracket 10, respectively. The guide sheet 20 is substantially circular, and is located in the center of the vent 11. Each of the four guide ribs 30 interconnects the corresponding planar portion 12 and a periphery of the guide sheet 20. The four guide ribs 30 are substantially centrosymmetrical with the guide sheet 20, and are centrosymmetrically, axisymmetrically or asymmetrically located in the vent 11. In the illustrated embodiment, the guide sheet 20 is centrosymmetrically located in the center of the vent 11.

Each guide rib 30 includes a first connecting portion 32, a second connecting portion 34 and a third connecting portion 36. Opposite ends of the second connecting portion 34 interconnect the first connecting portion 32 and the third connecting portion 36, respectively. The other ends of the first connecting portion 32 and the third connecting portion 36 are respectively connecting the corresponding planar portion 12 and the guide sheet 20. Each guide rib 30 defines a first angle α₁ between the first connecting portion 32 and the second connecting portion 34 and a second angle β₁ between the second connecting portion 34 and the third connecting portion 36. The first angle α₁ and the second angle β₁ are obtuse angles. In the illustrated embodiment, the first angle α₁ is about 100°. The second angle β₁ is about 120°.

It is to be understood that the number of the guide ribs 30 can also be two, three, or more than four. The first angle α₁ and the second angle β₁ can also be any angle less than 135°.

Each guide rib 30 defines the first angle α₁ and the second angle β₁ so as to form an included angle, respectively, such that the guide ribs 30 disperse airflow to reduce an air pressure of the fan outlet. Thus, the fan guard 100 can reduce noise while maintaining heat dissipation efficiency of the fan.

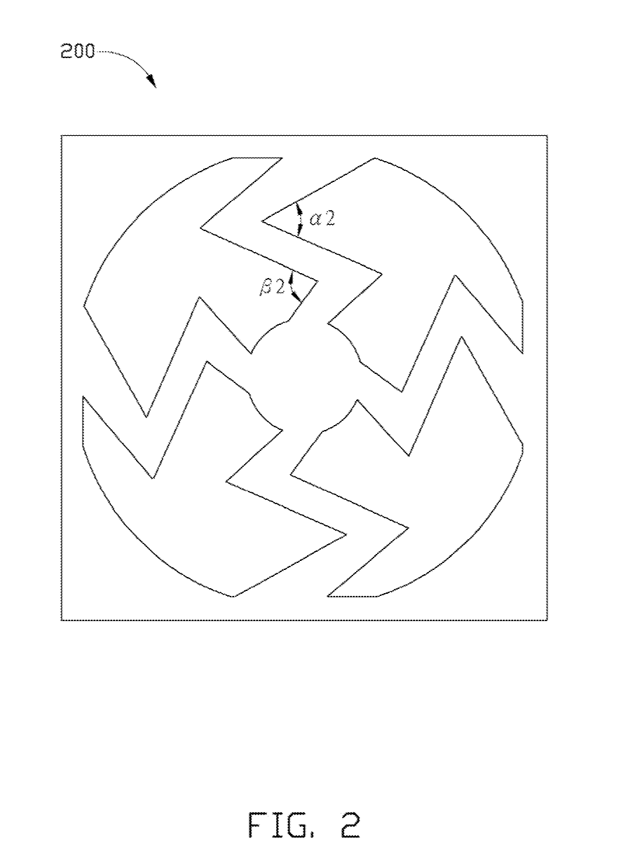

Referring to FIG. 2, a second embodiment of a fan guard 200 is shown, differing from the first embodiment only in that the first angle α₂ and the second angle β₂ are acute angles. In the illustrated embodiment, the first angle α₂ is about 75°, the second angle β₂ is about 80°.

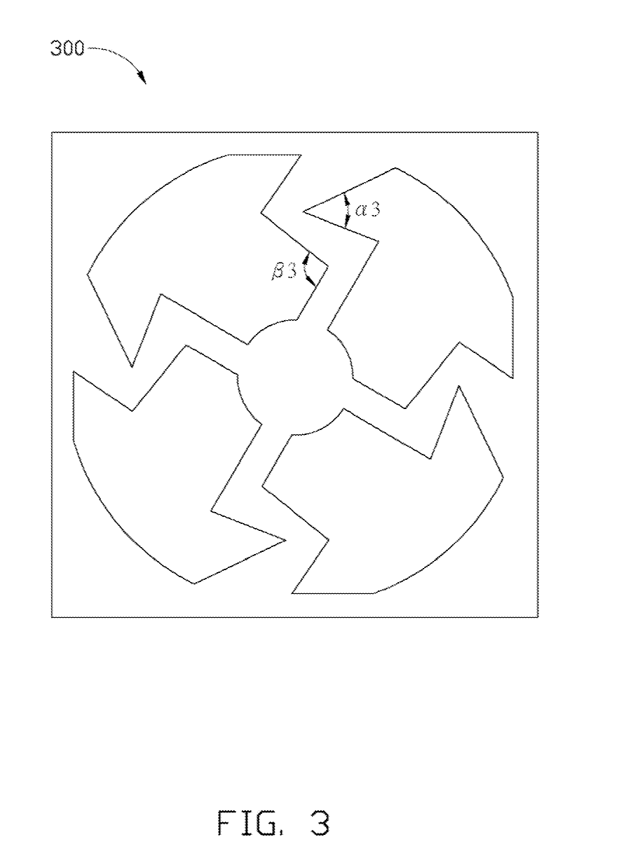

Referring to FIG. 3, a third embodiment of a fan guard 300 is shown, differing from the first embodiment only in that the first angle α₃ is an acute angle, and the second angle β₃ is an obtuse angle. In the illustrated embodiment, the first angle α₃ is about 45°, the second angle β₃ is about 110°.

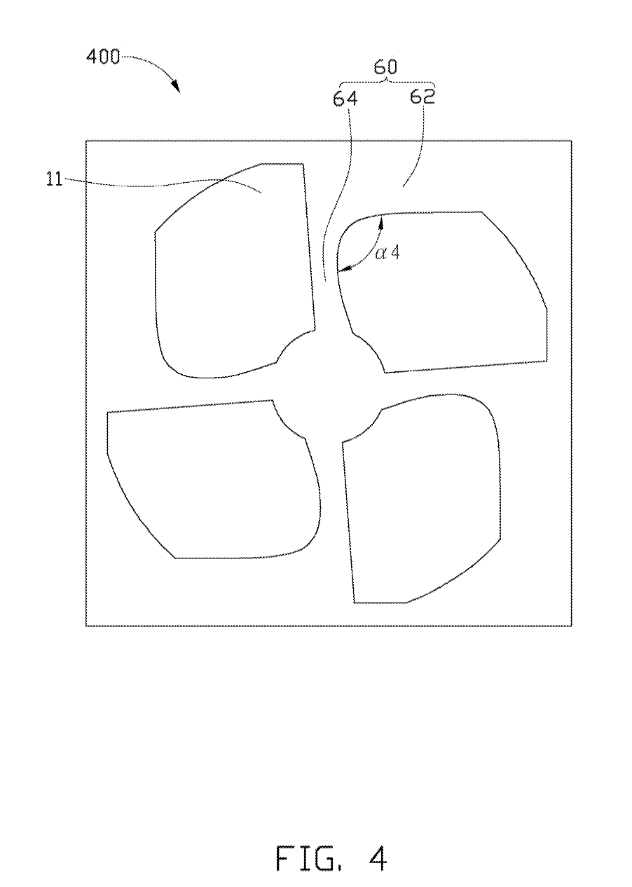

Referring to FIG. 4, a third embodiment of a fan guard 400 is shown, differing from the first embodiment only in that each guide rib 60 only defines the first angle α₄ between the first connecting portion 62 and the second connecting portion 64. A longer side of the second connecting portion 64 fully connects with the sidewall of the vent 11. In the illustrated embodiment, the first angle α₄ has a negative camber.

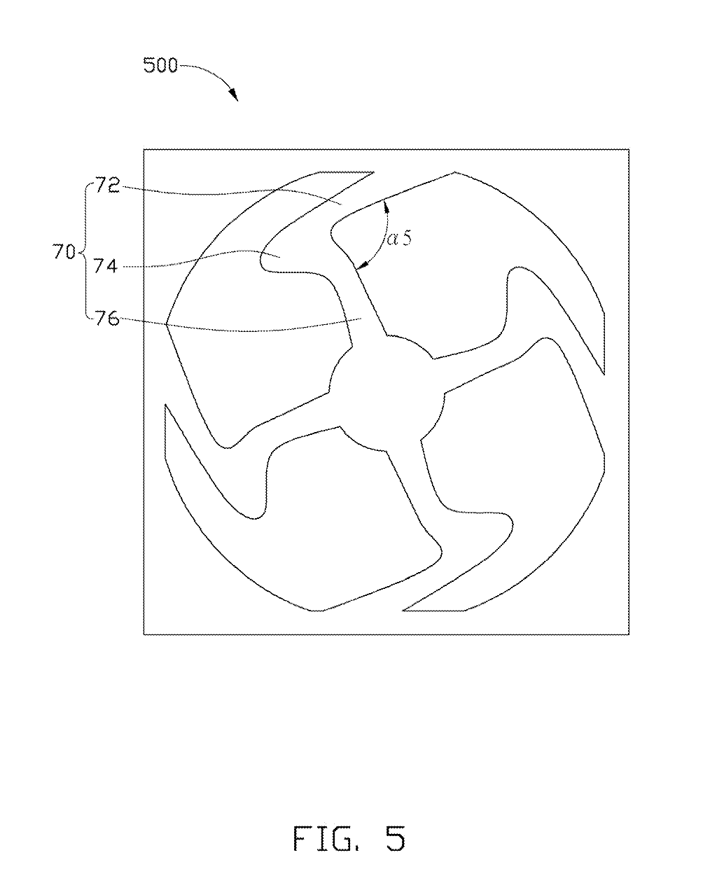

Referring to FIG. 5, a third embodiment of a fan guard 500 is shown, differing from the first embodiment only in that each guide rib 60 includes a first connecting portion 72, a second connecting portion 74 and a protrusion 76 arranged at an end of the first connecting portion 72 connecting the second connecting portion 74. The first angle α₅ has a negative camber.

A fan respectively mounted on the fan guards 100, 200, 300, 400, 500 was tested for loudness and prominence ratio. Experimental devices used included a fan (Sunon PMD 1240PPBA-A), a SQLab-III multichannel signal analyzer, a head acoustic analysis software (Artemis) and a microphone (GRAS 40AE). Measurement conditions of the tests are described as follow. A distance between the microphone and an inlet of the fan was 100 millimeters. A distance between the microphone and the fan guides 100, 200, 300, 400, 500 was about 104 millimeters. The rear side of the fan, away from the fan blades, mounted on a front surface of the fan guards 100, 200, 300, 400, 500 is referred to as “positive mounting”. The front side of the fan facing the fan blades mounted on a front surface of the fan guards 100, 200, 300, 400, 500, is referred to as “negative mounting”. A low rotation speed of the fan was about 5700 rpm. A high rotation speed of the fan was about 9700 rpm.

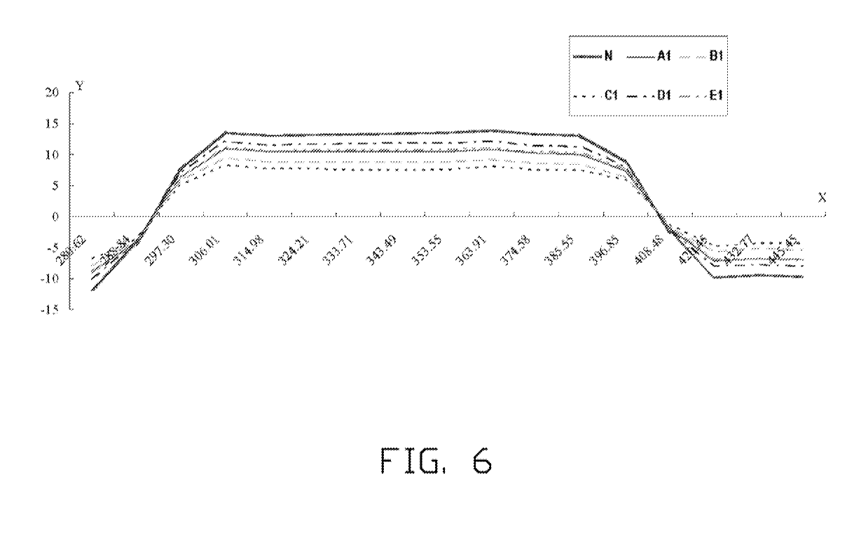

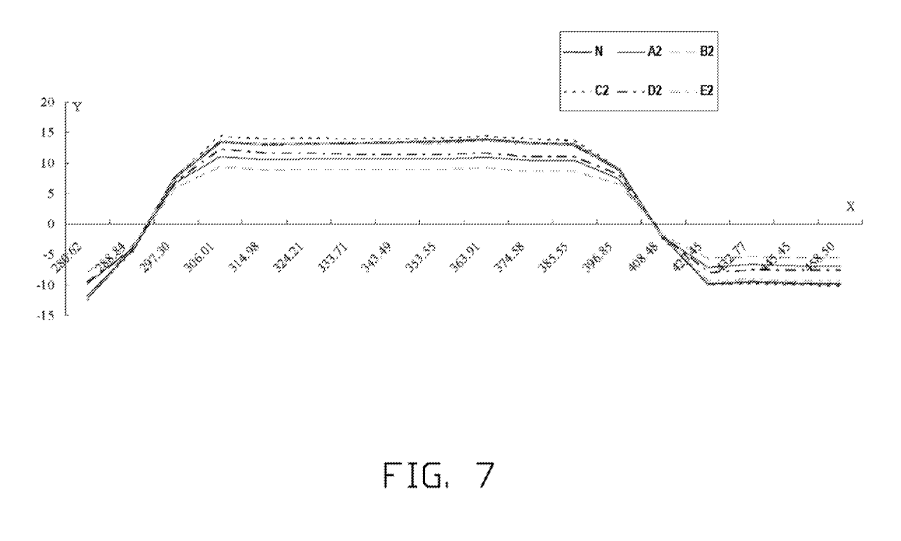

Referring to FIGS. 6 and 7, the results of a first prominence ratio testing of the fan are shown. The fan is positively or negatively mounted on the fan guards 100, 200, 300, 400, 500, and has a low rotation speed. The X axis represents a passing frequency of the fan measured in hertz (Hz). The Y axis represents a prominence ratio of the fan measured in decibels (dB). The curve N represents a test curve of the fan without any fan guard mounted on. The curves A1, B1, C1, D1, E1 represent the test curves of the fan positively mounted on the fan guards 100, 200, 300, 400, 500 respectively. The curves A2, B2, C2, D2, E2 represent the test curves of the fan negatively mounted on the fan guards respectively. It can be seen from FIG. 6 that a prominence ratio of the fan positively mounted on the fan guards 100, 200, 300, 400, 500 is lower than that of the fan without any fan guard mounted on. It can be seen from FIG. 7 that a prominence ratio of the fan negatively mounted on the fan guards 100, 200, 300, 400, 500 is lower than that of the fan without any fan guard mounted on.

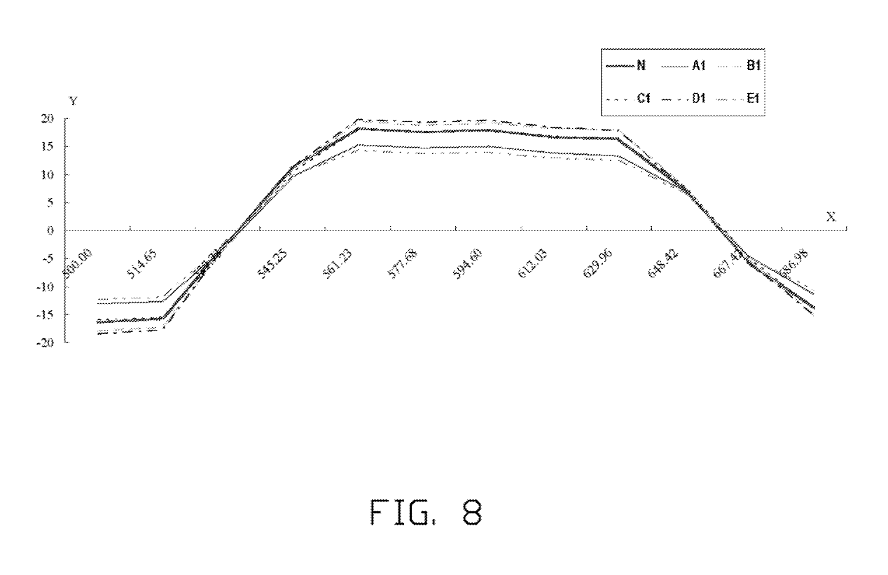

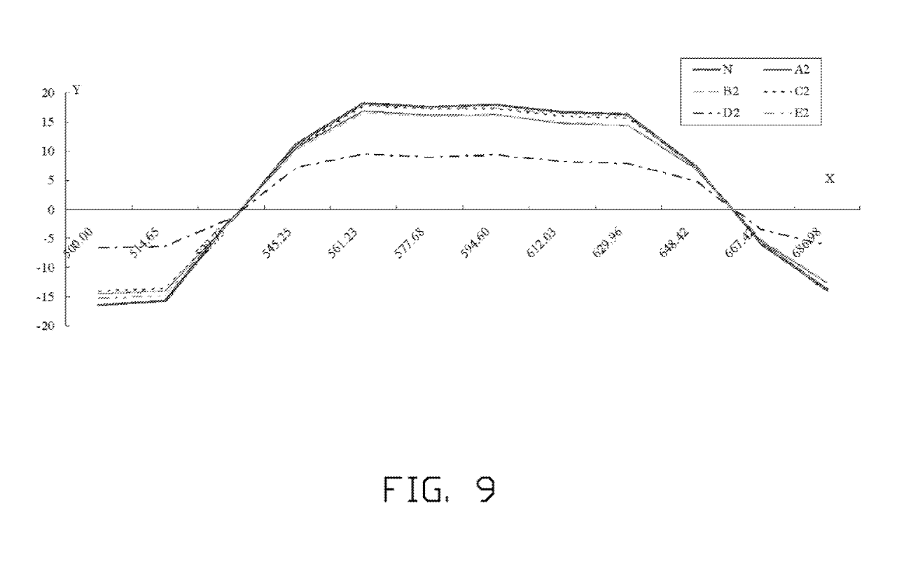

Referring to FIGS. 8 and 9, a second prominence ratio testing of the fan differs from the first test only in that the fan has a high rotation speed. It can be seen from FIG. 8 that a prominence ratio of the fan positively mounted on the fan guards 100, 200, 300, 400, 500 is lower than that of the fan without any fan guard mounted on. It can be seen from FIG. 9 that a prominence ratio of the fan negatively mounted on the fan guards 100, 200, 300, 400, 500 is lower than that of the fan without any fan guard mounted on.

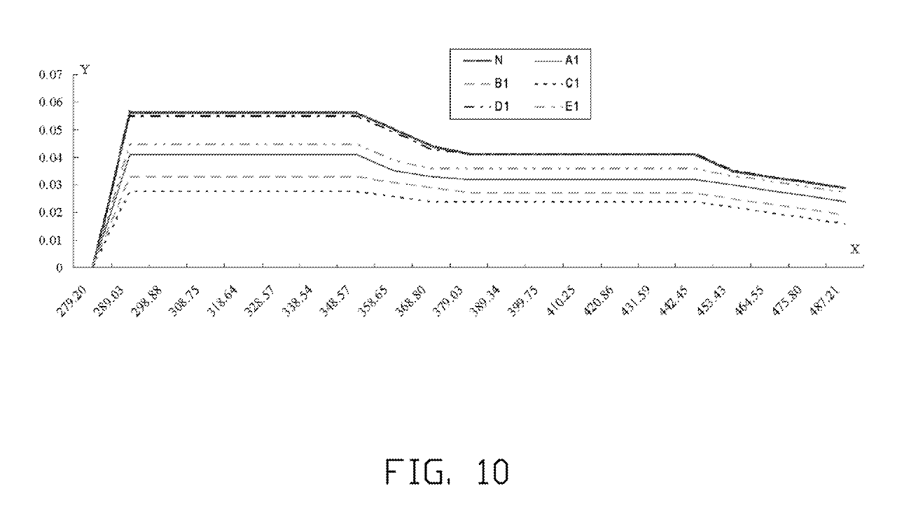

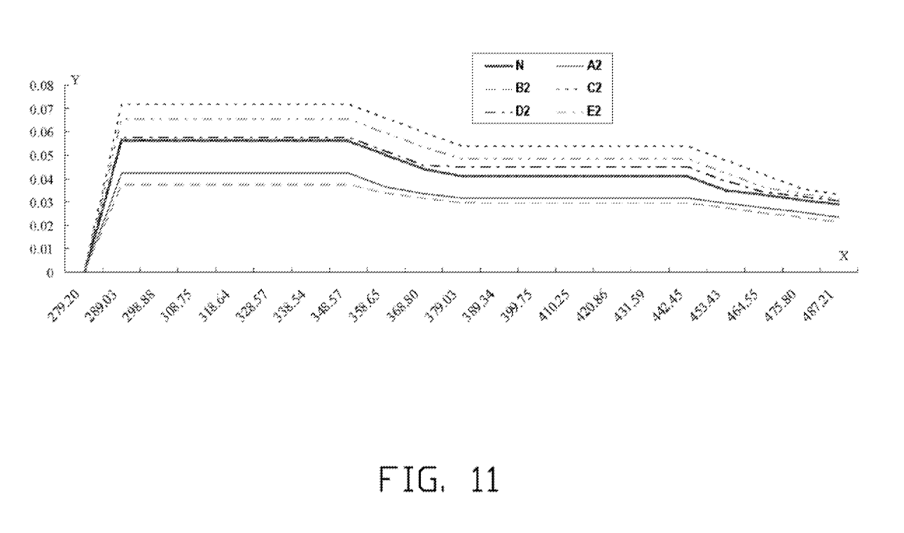

Referring to FIGS. 10 and 11, results of a third loudness testing of the fan are shown. The fan is positively or negatively mounted on the fan guards 100, 200, 300, 400, 500, and has a low rotation speed. The X axis represents a passing frequency of the fan measured in hertz (Hz). The Y axis represents a loudness of the fan measured in Sone. The curve N represents a test curve of the fan without any fan guard mounted on.

The curves A1, B1, C1, D1, E1 represent test curves of the fan positively mounted on the fan guards 100, 200, 300, 400, 500 respectively. The curves A2, B2, C2, D2, E2 represent test curves of the fan negatively mounted on the fan guards respectively. It can be seen from FIG. 10 that a loudness of the fan positively mounted on the fan guards 100, 200, 300, 400, 500 is lower than that of the fan without any fan guard mounted on. It can be seen from FIG. 11 that a loudness of the fan negatively mounted on the fan guards 100, 200, 500 is lower than that of the fan without any fan guard mounted on.

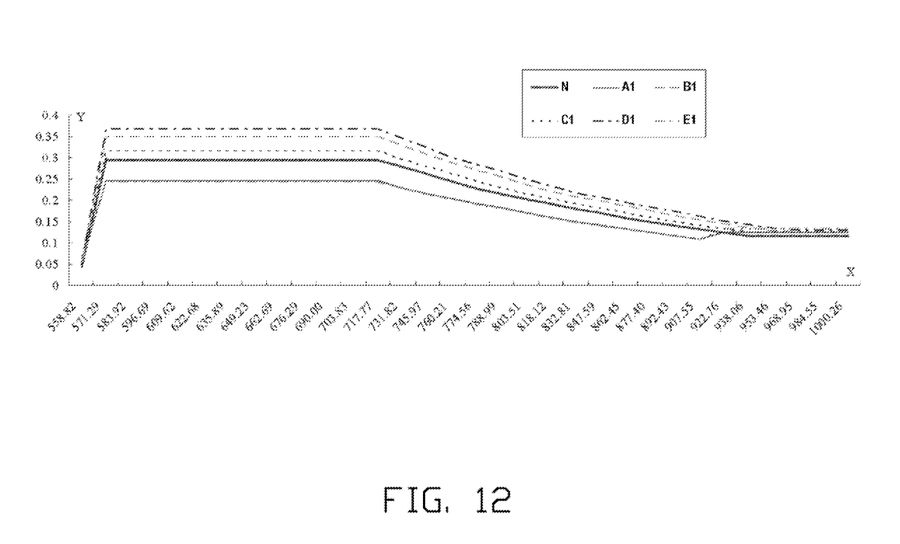

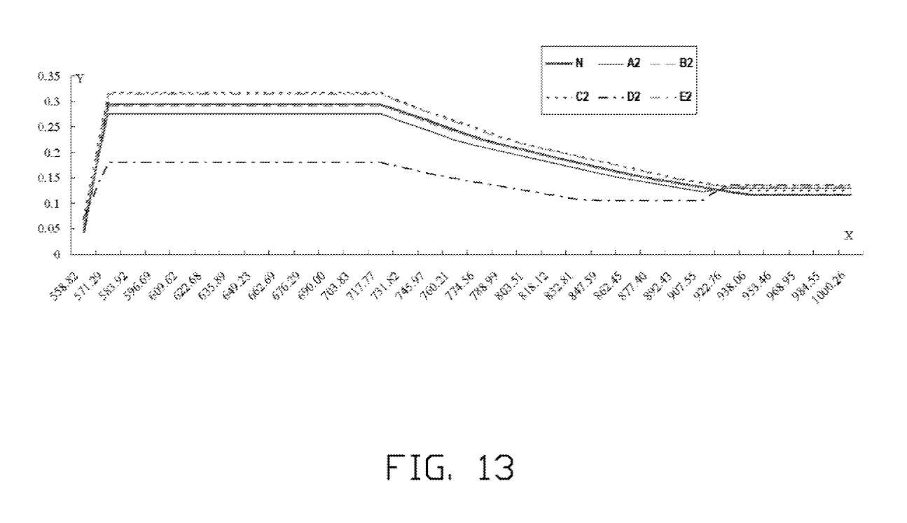

Referring to FIGS. 12 and 13, a fourth loudness testing of the fan differs from the third test only in that the fan has a high rotation speed. It can be seen from FIG. 12 that a loudness of the fan positively mounted on the fan guards 100, 500 is lower than that of the fan without any fan guard mounted on. It can be seen from FIG. 13 that a loudness of the fan negatively mounted on the fan guards 100, 200, 400 is lower than that of the fan without any fan guard mounted on.

As may be seen from the tests, when the fan guards 100, 200, 300, 400, 500 are positively or negatively mounted on the fan, noise reduction obtained by the fan guards 100, 200, 300, 400, 500 are different, as it can be further differentiated when the fan has a low rotation speed or a high rotation speed. Accordingly, the fan guards 100, 200, 300, 400, 500 can be seen to provide optimal noise reduction via the adjustment of rotation speeds and mounting positions. For example, when the fan has a low rotation speed and the fan guards 100, 200, 300, 400, 500 are positively mounted on the fan, the fan generates lower noise. When the fan has high rotation speed and the fan guards 100, 200, 300, 400, 500 are negatively mounted on the fan, the fan also generates lower noise.

Finally, while the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure as defined by the appended claims.

What is claimed is:

1. A fan guard comprising:
a bracket defining a vent in the center of the bracket;
a guide sheet located in the center of the vent; and
at least two guide ribs interconnecting the bracket and the guide sheet, wherein each guide rib comprises a first connecting portion and a second connecting portion connecting the first connecting portion, wherein the first connecting portion and the second connecting portion cooperatively define a first angle therebetween.

2. The fan guard of claim 1, wherein the bracket further defines at least two planar portions in the sidewalls of the vent, and each guide rib connecting the corresponding planar portion.

3. The fan guard of claim 1, wherein the first angle has a negative camber.

4. The fan guard of claim 3, wherein each guide rib comprises a protrusion at an end of the first connecting portion connecting the second connecting portion.

5. The fan guard of claim 3, wherein a longer side of the second connecting portion connects with a sidewall of the vent.

6. The fan guard of claim 1, further comprising a third connecting portion connecting the second connecting portion, wherein the third connecting portion and the second connecting portion cooperatively define a second angle therebetween.

7. The fan guard of claim 6, wherein the first angle and the second angle are obtuse angles.

8. The fan guard of claim 6, wherein the first angle is an acute angle and the second angle is an obtuse angle.

9. The fan guard of claim 6, wherein the first angle and the second angle are acute angles.

10. The fan guard of claim 6, wherein the first angle and the second angle are all less than 135°.

11. A fan guard comprising:
a bracket defining a vent in the center of the bracket;
a guide sheet located in the center of the vent; and
at least two guide ribs interconnecting the bracket and the guide sheet, wherein the least two guide ribs are substantially centrosymmetrical with the guide sheet and each defines a first angle in the center of the least two guide ribs.

12. The fan guard of claim 11, wherein the bracket further defines at least two planar portions in sidewalls of the vent, each guide rib connecting the corresponding planar portion.

13. The fan guard of claim 11, wherein the first angle has a negative camber.

14. The fan guard of claim 13, wherein each guide rib comprises a protrusion at the first angle.

15. The fan guard of claim 11, wherein the first angle is less than 135°.

16. The fan guard of claim 11, wherein each guide rib defines a second angle in the center of the guide rib.

17. The fan guard of claim 16, wherein the first angle and the second angle are obtuse angles.

18. The fan guard of claim 16, wherein the first angle is an acute angle and the second angle is an obtuse angle.

19. The fan guard of claim 16, wherein the first angle and the second angle are acute angles.

20. The fan guard of claim 16, wherein the first angle and the second angle are all less than 135°.
